(19) United States
(12) Patent Application Publication
(10) Pub. No.: US 2026/0074614 A1
(43) Pub. Date: Mar. 12, 2026

(54) POWER FACTOR CORRECTION IN A POWER CONVERTER

(71) Applicant: Infineon Technologies Austria AG, Villach (AT)

(72) Inventor: Pierrick AUSSERESSE, München, (DE)

(21) Appl. No.: 18/883,242

(22) Filed: Sep. 12, 2024

(51) Int. Cl. H02M 1/42

(52) U.S. Cl. CPC H02M 1/4241

(57) ABSTRACT

An apparatus such as a resonant power converter as discussed herein may include: a first transformer winding; sense circuitry operative to sense first energy supplied from an input voltage to the first transformer winding; and switch circuitry operative to apply power factor correction associated with conversion of the input voltage into an output voltage derived from an output of a second transformer magnetically coupled to the first transformer winding, the applied power factor correction including control of a flow of the first energy from the input voltage to the first transformer winding.

### BACKGROUND

As its name suggests, a conventional power converter converts a received input voltage into an output voltage. One type of conventional power converter receives an alternating voltage (AC voltage) and converts it into a respective DC output voltage.

### BRIEF DESCRIPTION

An apparatus such as a power supply or other suitable entity as discussed herein can be configured to include: a first winding; first bidirectional switch circuitry; and second bidirectional switch circuitry disposed in series with the first bidirectional switch circuitry. A combination of the first bidirectional switch circuitry and the second bidirectional switch circuitry can be configured to control a magnitude of current through the first winding to produce an output voltage.

As further discussed herein, the apparatus may further include a capacitor disposed in a series circuit path including the first winding. The series circuit path may be operative to support resonance of the current through/to the first winding. More specifically, the series circuit path including the capacitor disposed in series with the first winding may be a resonant circuit.

Yet further, note that the first winding may be disposed in a transformer. A second winding of the transformer may be magnetically coupled to the first winding of the transformer. In such an instance, a flow of the (first) current through the first winding induces (second) current to flow through the second winding. The windings of the transformer support conversion of a received input voltage into the output voltage as well as output of the output voltage from the second winding.

Still further, as discussed herein, the first bidirectional switch circuitry may be operative to block passage of current/voltage in both a first direction and a second direction through the first bidirectional switch circuitry; the second bidirectional switch circuitry may be operative to block passage of current/voltage in a first direction and a second direction through the second bidirectional switch circuitry.

In accordance with further examples as discussed herein, the first bidirectional switch circuitry and the second bidirectional switch circuitry can be implemented in any suitable manner. In one example, the first bidirectional switch circuitry may be a first GaN (Gallium Nitride) switch; the second bidirectional switch circuitry may be a second GaN (Gallium Nitride) switch.

Yet further, the first bidirectional switch circuitry may include a first switch disposed in series with a second switch; the second bidirectional switch circuitry may include a third switch disposed in series with a fourth switch; a combination of the first switch and the second switch may be disposed in a first series circuit path between a first node and a second node of the power converter; a combination of the third switch and the fourth switch are disposed in a second series circuit path between the second node and a third node of the power converter.

Additionally, the apparatus as discussed herein may be configured to include a controller operative to: during a first mode in which an input voltage between the first node and the third node is positive: i) activate both the first switch and the third switch to ON states, and ii) alternatingly switching between activating the second switch and the fourth switch to an ON state to control the magnitude of the current through the first winding. The controller may be further operative to: during a second mode in which the input voltage between the first node and the third node is negative: i) activate both the second switch and the fourth switch to ON states, and ii) alternatingly switch between activating the first switch and the third switch to an ON state to control the magnitude of the current through the first winding.

Still further, the apparatus such as a circuitry as discussed herein may be configured to include a transformer including the first winding and a second winding. The second winding may be magnetically coupled in the transformer to the first winding. In such an instance, a flow of the current through the first winding is operative to produce the output voltage where the output voltage is outputted from the second winding. The controller can be configured to regulate a magnitude of the output voltage via switching between operation in the first mode and the second mode as well as implementing switch control in each of the first mode and the second mode.

Further examples as discussed herein include a configuration in which the first bidirectional switch circuitry may be a first dual gate switch including a first drain node, a first source node, a first gate node, and a second gate node. The second switch circuitry may be a second dual gate switch including a second drain node, a second source node, a third gate node, and a fourth gate node.

Another example as discussed herein includes a controller. The controller can be configured to: during a first mode in which an input voltage between the first node and the third node is positive: i) apply ON control signals to the first gate node and the third gate node, and ii) switch between applying an ON control signal to the second gate node and the fourth gate node to control the magnitude of the current through the first winding. Additionally, or alternatively, the controller can be further configured to: during a second mode in which an input voltage between the first node and the third node is negative: i) apply ON control signals to the second gate node and the fourth gate node, and ii) switch between applying an ON control signal to the first gate node and the third gate node to control the magnitude of the current through the first winding.

In another example, the controller is operative to regulate a magnitude of the output voltage via switching between operation in the first mode and the second mode.

Still further examples as discussed herein include the apparatus further including: a first capacitor disposed in parallel with a combination of the first bidirectional switch circuitry and the first winding; and a second capacitor disposed in parallel with a combination of the second bidirectional switch circuitry and the first winding.

The apparatus as discussed herein may further include a first capacitor. The first bidirectional switch circuitry may be directly connected to the second bidirectional switch circuitry via a first node, the first capacitor may be disposed in series between the first node and the first winding. The apparatus may further include a controller operative to control the first bidirectional switch circuitry and the second bidirectional switch circuitry based upon a feedback signal generated that a second node directly connecting the first capacitor and the first winding.

Further examples as discussed herein include a method comprising: controlling operation of first bidirectional switch circuitry; controlling operation of second bidirectional switch circuitry disposed in series with the first bidirectional switch circuitry; and wherein the controlled operation of the first bidirectional switch circuitry and the second bidirectional switch circuitry controls a magnitude of current through the first winding to produce an output voltage.

As previously discussed, the first bidirectional switch circuitry can be configured to include a first switch disposed in series with a second switch; the second bidirectional switch circuitry can be configured to include a third switch disposed in series with a fourth switch. A combination of the first switch and the second switch may be disposed in a first series circuit path between a first node and a second node. A combination of the third switch and the fourth switch may be disposed in a second series circuit path between the second node and a third node. In such an instance, the method may further include, via a controller: during a first mode in which an input voltage between the first node and the third node is positive: i) activating both the first switch and the third switch to ON states, and ii) alternatingly switching between activating the second switch and the fourth switch to an ON state to control the magnitude of the current through the first winding. For example, in the first mode, when the first switch is on, the second switches off; and the first switch is off, the second switch is on.

Yet further, examples as discussed herein include, via the controller, during a second mode in which the input voltage between the first node and the third node is negative: i) activating both the second switch and the fourth switch to ON states, and ii) alternatingly switching between activating the first switch and the third switch to an ON state to control the magnitude of the current through the first winding. For example, in the second mode, when the first switch is on, the second switch is off; and the first switch is off, the second switch is on.

These and other more specific examples are disclosed in more detail below.

Further examples as discussed herein include an apparatus comprising: a first transformer winding; sense circuitry operative to sense first energy supplied from an input voltage to the first transformer winding; and switch circuitry operative to apply power factor correction associated with conversion of the input voltage into an output voltage derived from an output of a second transformer magnetically coupled to the first transformer winding, the applied power factor correction operative to control a flow of the first energy from the input voltage to the first transformer winding.

The output voltage may supply second energy to a respective load. The apparatus may further include a controller operative to: i) monitor a magnitude of the first energy via feedback from the sense circuitry, and ii) apply the power factor correction via controlled operation of the switch circuitry such that an average magnitude of the first energy supplied from the input voltage to the first transformer winding may substantially equal to an average magnitude of the second energy supplied from the second transformer winding to the respective load.

Yet further, the sense circuitry may include a first capacitor. The apparatus may further include a series circuit path including the first capacitor coupled in series with the first transformer winding. The apparatus may further include a controller operative to, via control of the switch circuitry, control a flow of resonant current through the series circuit path, the flow of resonant current controlled based on the applied power factor correction.

In further examples as discussed herein, the sense circuitry can be configured to include a capacitor operative to sense a magnitude of the first energy supplied from the input voltage through the switch circuitry to the first transformer winding. The output voltage may be derived from the output of the second transformer winding may operative to supply second energy to a respective load. The apparatus may further include a controller operative to: i) monitor feedback received from the sense circuitry, the feedback indicating the magnitude of the first energy, and ii) via the power factor correction, control operation of the switch circuitry such that an average magnitude of the first energy over multiple control cycles may substantially equal to an average magnitude of the second energy over the multiple control cycles.

In still further examples, the sense circuitry as discussed herein can be configured to include a series circuit path including a first capacitor disposed in series with a first switch, the series circuit path disposed in parallel with the first transformer winding.

In another example, the sense circuitry may include a sense capacitor operative to store a voltage value indicating an integral of current supplied by the input voltage through the first transformer winding.

The apparatus as discussed herein may further include: a signal generator circuit operative to produce a threshold signal based at least in part on a magnitude of the output voltage with respect to a setpoint reference voltage; and a controller operative to control the switch circuitry and the flow of the first energy from the input voltage to the first transformer winding based upon the threshold signal to apply the power factor correction.

Another apparatus as discussed herein includes a controller. The controller can be configured to: via control of switch circuitry, control a flow of first energy received from an input voltage through a first transformer winding magnetically coupled to a second transformer winding, the controlled flow of the first energy through the first transformer winding to the second transformer winding operative to produce an output voltage based on second energy supplied from an output of the second transformer winding to a load; receive feedback indicative of a magnitude of the first energy; and adjust operation of the switch circuitry over time based on at least the feedback and a magnitude of the output voltage, the adjusted operation of the switch circuitry operative to adjust a magnitude of the first energy supplied to the first transformer winding.

Still further examples as discussed herein include a method comprising: via switch circuitry, controlling a flow of first energy received from an input voltage through a first transformer winding, the first transformer winding magnetically coupled to a second transformer winding, the controlled flow of the first energy through the first transformer winding to the second transformer winding producing an output voltage based on second energy supplied from an output of the second transformer winding to a load; receiving feedback indicative of a magnitude of the first energy; and applying power factor correction via control of the switch circuitry over time based on at least the received feedback and a magnitude of the output voltage, the control of the switch circuitry including adjustment of a magnitude of the first energy supplied to the first transformer winding.

Controlling the flow of the first energy may include controlling resonant current supplied by the input voltage through the first transformer winding.

Still further, the control of the switch circuitry over time can be configured to substantially equalize an average magnitude of the first energy and an average magnitude of the second energy.

As further discussed herein, the control of the switch circuitry over time may include: adjusting operation of the switch circuitry over time based on one or more of: i) the feedback indicative of the magnitude of the first energy, ii) the magnitude of the output voltage, iii) a magnitude of the input voltage, iv) a capacitance associated with sense circuitry producing the feedback, and iv) a switching period of controlling the switch circuitry.

Still further, control of the switch circuitry may include: producing a threshold signal; comparing the feedback indicative of the magnitude of the first energy to the threshold signal; and terminating flow of first current through the first transformer winding based on the comparing. The magnitude of the threshold signal may vary over time based on a magnitude of the input voltage.

Further, the method as discussed herein may include: producing the threshold signal based on a combination of: i) the magnitude of the output voltage with respect to a setpoint reference voltage, ii) a magnitude of the input voltage, and iii) a capacitance associated with sense circuitry producing the feedback.

In another example, the threshold signal is threshold signal TS. Producing the threshold signal TS may include: setting the threshold signal TS=OSV−[(tsw1/(K*C))*Vin]−cmp, where OSV is an offset value, where tsw1 is a measure of a period of controlling the switch circuitry, where C is a capacitance associated with sense circuitry producing the feedback, where K is a value based on an error voltage derived from comparing the magnitude of the output voltage to a setpoint reference voltage, and where Vin is the magnitude of the input voltage, and where cmp is an optional compensation factor against currents induced by the input voltage AC line in the sense circuitry.

Still further, the method as discussed herein may include receiving the feedback from sense circuitry. The feedback may be generated by the sense circuitry based on integration of a magnitude of first current supplied from the input voltage through the first transformer winding. The first transformer may be disposed in a resonant circuit, where the first current is resonant current flowing through the first transformer winding.

Note further that although examples as discussed herein are applicable to controlling operation of a power converter, the concepts disclosed herein may be advantageously applied to any other suitable topologies.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating a configuration of a power converter as discussed herein.

FIG. 2A is a diagram illustrating different example implementations of bidirectional switch circuitry as discussed herein.

FIG. 2B is a diagram illustrating an example implementation of bidirectional switch circuitry as discussed herein.

FIG. 3 is an example detailed diagram illustrating a power converter circuit implementing multiple instances of bidirectional switch circuitry to convert an input voltage into an output voltage as discussed herein.

FIG. 4 is an example timing diagram illustrating control of respective bidirectional switch circuitry in a power converter to convert an input voltage into an output voltage as discussed herein.

FIG. 5 is an example method of operating a respective power converter circuit including multiple instances of bidirectional switch circuitry to convert an input voltage into an output voltage as discussed herein.

FIG. 6 is an example circuit diagram illustrating a power converter as discussed herein.

FIG. 7 is an example circuit diagram illustrating implementation of a power converter and corresponding control as discussed herein.

FIG. 8 is an example diagram illustrating derivation of a control method using a generated threshold level as discussed herein.

FIG. 9 is a timing diagram illustrating control of a respective power converter over multiple AC input voltage cycles as discussed herein.

FIG. 10 is an example timing diagram illustrating control of a respective power converter as discussed herein.

FIG. 11 is an example diagram illustrating control of a respective power converter as discussed herein.

FIG. 12 is an example circuit diagram illustrating power flow sensing and control as discussed herein.

FIG. 13 is an example diagram illustrating a sense circuit configured to monitor a magnitude of current (first power) through a respective primary transformer winding as discussed herein.

FIG. 14 is an example diagram illustrating a sense circuit configured to monitor a magnitude of current (first power) through a respective primary transformer winding as discussed herein.

FIG. 15 is an example diagram illustrating a sense circuit configured to monitor a magnitude of current (first power) through a respective primary transformer winding as discussed herein.

FIG. 16 is an example method of controlling a respective resonant/flyback power converter to provide power factor correction as discussed herein.

The foregoing and other objects, features, and advantages of examples herein will be apparent from the following more particular description herein, as illustrated in the accompanying drawings in which like reference characters refer to the same parts throughout the different views. The drawings are not necessarily to scale, with emphasis instead being placed upon illustrating the examples, principles, concepts, etc.

### DETAILED DESCRIPTION

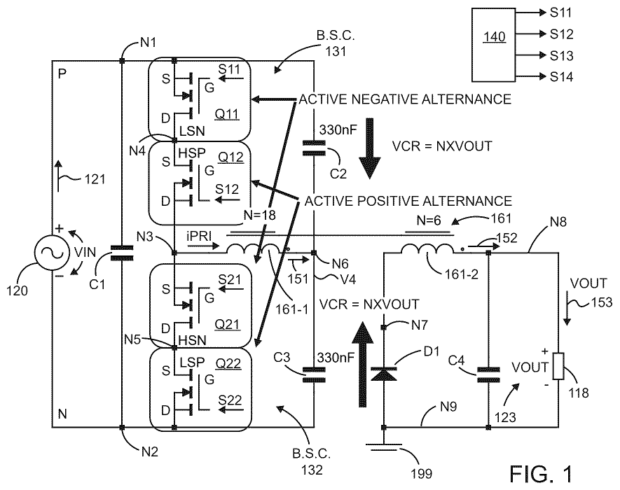

Now, with reference to the drawings, FIG. 1 is a diagram illustrating a power supply including a bridgeless hybrid flyback using bidirectional circuitry according to examples herein.

As shown in FIG. 1, the power converter 100 includes a power source 120, bidirectional switch circuitry 131, bidirectional switch circuitry 132, transformer 161, capacitor C1, capacitor C2, capacitor C3, capacitor C4, diode D1, and load 118.

The bidirectional switch circuitry 131 includes switch Q11 and switch Q12. The bidirectional switch circuitry 132 includes switch Q21 and switch Q22.

Transformer 161 includes primary winding 161-1 and secondary winding 161-2. The secondary winding 161-2 is magnetically coupled (inductively coupled) to the primary winding 161-1. The primary winding 161-1 is connected between node N3 and node N6. The secondary winding 161-2 is connected between the node N7 and node N8.

The power source 120 providing the input voltage Vin (such as an AC voltage or input voltage 121) is connected between the node N1 and node N2. Accordingly, the voltage across the node N1 and node N2 is Vin. The capacitor C1 (such as a standard EMI capacitor or electromagnetic interference capacitor) is disposed in parallel with the power source 120 between the node N1 and node N2 to filter high frequency currents and store a small charge associated with the input voltage Vin.

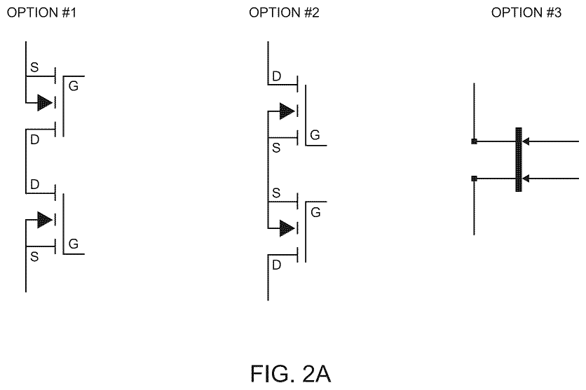

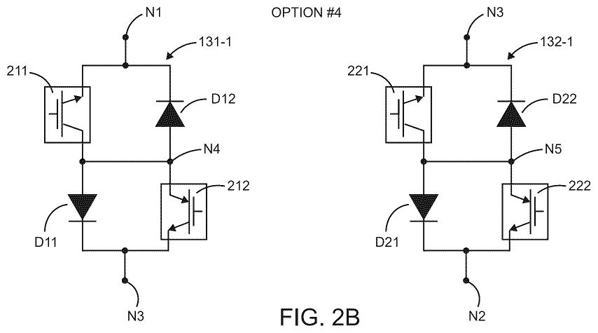

Note that the bidirectional switch circuitry 131 or 132 can be configured in any suitable manner. A non-limiting example of one implementation of the bidirectional switch circuitry associated with the power converter 100 is shown in FIG. 2. The bidirectional switch circuitry shown in FIG. 2 is discussed in more detail below.

Referring again to FIG. 1, it is noted that the source node S of the switch Q11 is connected to the node N1. The drain node D of switch Q11 is connected to node N4 and corresponding drain node D of switch Q12. The source node S of switch Q12 is connected to node N3 and corresponding source node S of switch Q21. The drain node D of switch Q21 is connected to the drain node D of switch Q22. The source node S of switch Q22 is connected to the node N2.

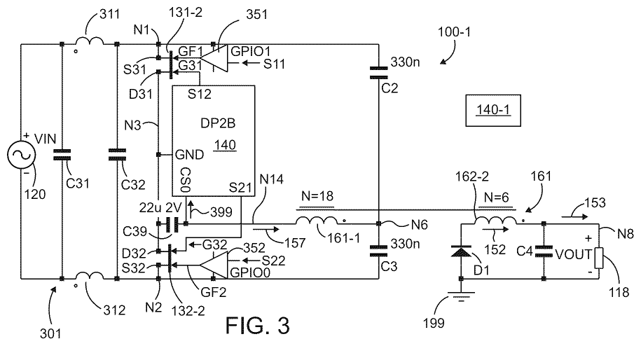

Note that the bidirectional switch circuitry as discussed herein can be configured in any suitable manner. For example, a first option #1 of the bidirectional switch circuitry as discussed herein is shown in FIG. 2A such as having a common drain connection; a second option #2 of the bidirectional switch circuitry as discussed herein is shown in FIG. 2A such as having a common source connection; a and a BDS switch option #3 is shown in FIG. 2A. Note that FIG. 1 illustrates implementation of the first option #1; FIG. 3 illustrates implementation of the option #3. A further option #4 of the bidirectional switch circuitry (such as so-called IGBT or Insulated-Gate Bipolar Transistor) is discussed in FIG. 2B below.

Yet further, as shown in FIG. 1, the capacitor C2 is connected between the node N1 and the node N6. The capacitor C3 is connected between the node N6 and the node N2.

Each of the capacitors C2 and C3 can be any suitable capacitance value.

Accordingly, a combination of the bidirectional switch circuitry 131 and the bidirectional switch circuitry 132 are connected in series between the node N1 and node N2. The series circuit path including the bidirectional switch circuitry 131 and the bidirectional switch circuitry 132 is disposed in parallel with the power source 120 and corresponding capacitor C1.

Note further that the power converter 100 shown in FIG. 1 can be configured to include a controller 140.

In one example, the controller 140 produces the control signal S11 (a.k.a., LSN) to drive the gate node G of switch Q11. The control signal S11 is used to control the switch Q11 between an ON-state and an OFF-state.

The controller 140 produces the control signal S12 (a.k.a., HSP) to drive the gate node G of switch Q12. The control signal S12 is used to control the switch Q12 between an ON-state and an OFF-state.

The controller 140 produces the control signal S21 (a.k.a., HSN) to drive the gate node G of switch Q21. The control signal S21 is used to control the switch Q21 between an ON-state and an OFF-state.

The controller 140 produces the control signal S22 (a.k.a., LSP) to drive the gate node G of switch Q22. The control signal S22 is used to control the switch Q22 between an ON-state and an OFF-state.

As shown in this example, and as previously discussed, each instance of the bidirectional switch circuitry as discussed herein is configured to selectively block or conduct current independently of voltage directions.

For example, the bidirectional switch circuitry 131 can be controlled to prevent conveyance of the voltage/current at node N1 to the node N3.

The bidirectional switch circuitry 131 can be controlled to prevent conveyance of the voltage/current at node N3 to the node N1.

In similar manner, the bidirectional switch circuitry 132 can be controlled to prevent a flow of current from the node N2 to the node N3.

The bidirectional switch circuitry 132 can be controlled to prevent the flow of current from the node N3 to the node N2.

It is noted that flow of current 151 (such as varying in magnitude) through the primary winding 161-1 may cause a respective flow of current 152 through the secondary winding 161-2. The flow of current 152 through the secondary winding 161-2 produces the output voltage 123 (a.k.a., Vout) across the capacitor C4 and load 118.

Note further that there are two phases: one for intake current 151 only and one for transfer current 151 and 152 at the same time.

Diode D1 prevents the current 152 from flowing in a negative direction through the secondary winding 161-2. In other words, the secondary current 152 through the secondary winding 161-2 flows in a direction from node N7 to node N8. Diode D1 prevents flow of current from node N7 through the diode D1 to the node N9 when diode D1 block is in the energy intake phase.

Note that the power converter 100 in FIG. 1 is shown by way of nonlimiting example. As further discussed below, the power converter 140 as discussed herein also can be implemented as shown in FIG. 3 or yet implemented via other configurations.

Thus, referring again to FIG. 1, the apparatus as discussed herein such as a power supply, power converter, or other suitable entity can be configured to include: a first winding 161-1; first bidirectional switch circuitry 131; and second bidirectional switch circuitry 132 disposed in series with the first bidirectional switch circuitry 131. A combination of the first bidirectional switch circuitry 131 and the second bidirectional switch circuitry 132 can be configured to control a magnitude of current 151 through the first winding 161-1 of the transformer 161 to produce an output voltage 123 (a.k.a., Vout).

Yet further, the second winding 161-2 of the transformer 161 may be magnetically coupled to the first winding 161-1 of the transformer 161. In such an instance, a flow of the current 151 (a.k.a., iPRI) through the first winding 161-1 is operative to convert a received input voltage Vin and corresponding current 121 into the output voltage 153 (a.k.a., Vout) via output of the output voltage 153 and corresponding current 152 from the second winding 161-2 to the load 118.

Still further, as previously discussed, the first bidirectional switch circuitry 131 may be operative to block passage of voltage in both a first direction and a second direction through the first bidirectional switch circuitry 131; the second bidirectional switch circuitry 132 may be operative to block passage of voltage in a first direction and a second direction through the second bidirectional switch circuitry 132.

Yet further, the first bidirectional switch circuitry 131 may include a first switch Q11 disposed in series with a second switch Q12; the second bidirectional switch circuitry 132 may include a third switch Q21 disposed in series with a fourth switch Q22.

A combination of the first switch Q11 and the second switch Q12 may be disposed in a first series circuit path between a node N1 and a node N3; a combination of the third switch Q21 and the fourth switch Q22 may be disposed in a second series circuit path between the node N3 and node N2.

Still further, as shown in FIG. 1, examples as discussed herein include the power converter 100 further including: a capacitor C2 disposed in parallel with a combination of the first bidirectional switch circuitry 131 and the first winding 161-1; and a capacitor C3 disposed in parallel with a combination of the second bidirectional switch circuitry 132 and the first winding 161-1.

A first circuit path including the capacitor C2 and the winding 161-1 is a first resonant circuit; a second circuit path including the capacitor C3 and the winding 161-1 is a second resonant circuit. The first resonant circuit path is disposed in parallel with the second resonant circuit path.

Further, as previously discussed, the bidirectional switch circuitry such as bidirectional switch circuitry 131, and bidirectional switch circuitry 132 can be implemented in any suitable manner. One example of the bidirectional switch circuitry 131 and bidirectional switch circuitry 132 is shown in FIG. 2.

FIG. 2B is a diagram illustrating an example implementation of a bidirectional switch as discussed herein.

In this example, an implementation of the bidirectional switch circuitry 131 (such as bidirectional switch circuitry 131-1) may include transistor 211, transistor 212, diode D11, and diode D12.

The transistor 211 and the diode D11 can be connected with each other at node N4. The combination of transistor 211 and the diode D11 may be disposed in series between the node N1 and node N3.

The diode D12 and the transistor 212 may be connected with each other at node N4 and are disposed in series between the node N1 and node N3.

An implementation of the bidirectional switch circuitry 132 (such as bidirectional switch circuitry 132-1) may include transistor 221, transistor 222, diode D21, and diode D22. The transistor 221 and the diode D21 may be connected with each other at node N5 and may be disposed in series between the node N2 and node N3. The diode D22 and the transistor 222 may be connected with each other at node N5 and may be disposed in series between the node N2 and node N3.

Another example of implementing the first bidirectional switch circuitry 131 and the second bidirectional switch circuitry 132 in an AC-DC power converter is shown in FIG. 3. It is noted that the output voltage 153 maybe a DC voltage.

FIG. 3 is an example power converter circuit diagram illustrating implementation of multiple dual gate bidirectional switches such as Gallium Nitride (GaN) switches in a power converter to convert an input voltage into an output voltage as discussed herein.

As previously discussed, the first bidirectional switch circuitry 131 and the second bidirectional switch circuitry 132 can be implemented in any suitable manner.

In one example, the first bidirectional switch circuitry 131 may be implemented as dual gate bidirectional switch circuitry 131-2 such as a first GaN (Gallium Nitride) switch. The second bidirectional switch circuitry 132 may be implemented as dual gate bidirectional switch circuitry 132-2 such as a second GaN (Gallium Nitride) switch.

As further shown in FIG. 3, the first bidirectional switch circuitry 131-2 may be a first dual gate switch including a first drain node D31, a first source node S31, a first gate node GF1 (such as a floating gate), and a second gate node G31.

The second bidirectional switch circuitry 132-1 may be a second dual gate switch including a drain node D32, a source node S32, a gate node GF2 (such as a floating gate), and a gate node G32.

The power converter 100-1 further includes the EMI cancelation circuit 301 such as including the capacitor C31, capacitor C32 (similar to capacitor C1 in FIG. 1), inductor 311, and inductor 312. If desired, the controller 140 or other suitable entity provides power factor correction.

In this example, the power converter 100-1 further includes capacitor C39 disposed in series with the transformer winding 161-1 between the node N3 and the node N6. The series circuit path can be configured to support current sensing.

As further shown, the power converter 100-1 can be configured to include controller 140-1 (operating similar to controller 140) to control the first bidirectional switch circuitry 131-2 and the second bidirectional switch circuitry 132-2 based upon a feedback signal 399 (such as voltage) generated at node N14 directly connecting the capacitor C39 and the first winding 161-1.

Note that the control can be configured to monitor feedback from any suitable node to control the first bidirectional switch circuitry and the second bidirectional switch circuitry. For example, additional examples as discussed herein may include monitoring the node N6 or N8 to control the switch circuitry.

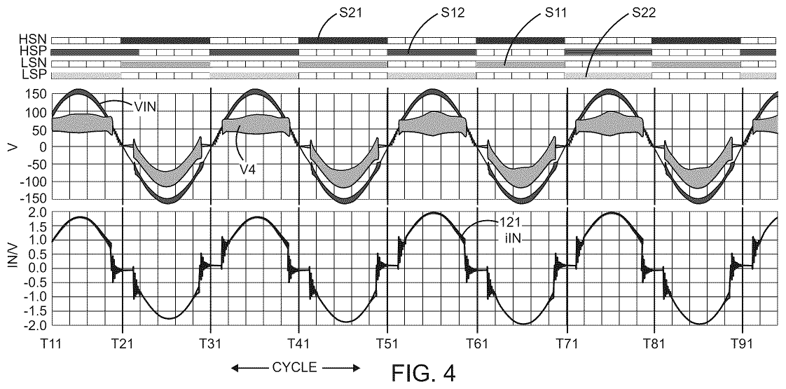

FIG. 4 is an example timing diagram illustrating control of respective bidirectional switch circuitry in a power converter to convert an input voltage into an output voltage as discussed herein.

With reference to the power converter 100 in FIG. 1 and timing diagram 400 in FIG. 4, during a first mode (when the polarity of the input voltage Vin is positive) such as between time T31 and time T41 in which the input voltage Vin between the node N1 and the node N2 is positive such as detected by the controller 140 or other suitable entity, the controller 140: i) activates both the switch Q11 (via driving the control signal S11 to a logic high between time T31 and time T41) and the switch Q21 to ON states (via setting the control signal S21 to a logic high between time T31 and time T41), and ii) alternatingly switches between activating the second switch Q12 and the fourth switch Q22 to an ON state to control the magnitude of the current 151 through the first winding 161-1.

In other words, during the first mode between time T31 and time T41, when the controller 140 activates switch Q12 to an ON-state, the controller 140 deactivates switch Q22 to an OFF-state. Conversely, when the controller 140 deactivates switch Q12 to an OFF-state, the controller 140 activates the switch Q22 to an ON-state.

Note that the switching frequency of controlling the switches Q12 and Q22 on and off between time T31 and time T41 is substantially greater than the line frequency (as defined by the period of the input voltage Vin between time T31 and time T51) associated with the input voltage Vin.

Between time T51 and time T61, between time T71 and time T81, etc., the controller 140 controls operation of the respective bidirectional switch circuitry 131 and bidirectional switch circuitry 132 in a similar manner as discussed above (the first mode) for the time duration between time T31 and time T41.

Between time T21 and time T31, between time T41 and time T51, between time T61 and time T71, etc., the controller 140 operates in a second mode (when the polarity of the input voltage Vin is negative).

During the second mode in which the input voltage Vin between the node N1 and the node N2 is negative, the controller 140: i) activates the bidirectional switch circuitry Q12 and bidirectional switch circuitry Q22 to ON states between time T41 and time T51, and ii) switches between activating the bidirectional switch circuitry Q11 and the bidirectional switch circuitry Q21 to an ON state to control the magnitude of the current 151 through the first winding 161-1.

In other words, during the second mode between time T41 and time T51, when the controller 140 activates switch Q11 to an ON-state, the controller 140 deactivates switch Q21 to an OFF-state. Conversely, when the controller 140 deactivates switch Q11 to an OFF-state, the controller 140 activates the switch Q21 to an ON-state.

Note that the switching frequency of controlling the switches Q11 and Q12 on and off between time T41 and time T51 is substantially greater than the line frequency (as defined by the period of the input voltage Vin between time T31 and time T51) associated with the input voltage Vin.

Between time T21 and time T31, between time T61 and time T71, etc., the controller 140 controls operation of the respective bidirectional switch circuitry 131 and bidirectional switch circuitry 132 in a similar manner as discussed above (the first mode) for the time duration between time T41 and time T51.

As previously discussed, the second winding 161-2 may be magnetically coupled in the transformer 161 to the first winding 161-1. In such an instance, a flow of the current 151 through the first winding 161-1 is operative to induce flow of current 152 through the secondary winding 161-2 to produce the output voltage 153, where the output voltage 153 is outputted from the second winding 161-2 to the load 118 and corresponding capacitor C4. The controller 140 can be configured to regulate a magnitude of the output voltage 153 via switching between operation in the first mode and the second mode.

With reference to the power converter 100-1 in FIG. 3 and timing diagram 400 in FIG. 4, during a first mode (when the polarity of the input voltage Vin is positive) such as between time T31 and time T41 in which the input voltage Vin between the node N1 and the node N2 is positive such as detected by the controller 140-1 or other suitable entity, the controller 140-1: i) produces the control signal S11 applied to the gate node GF1 to be a logic high between time T31 and time T41 and produces the control signal S21 supplied to the gate node G32 to be a logic high between time T31 and time T41, and ii) switches between generating the control signal S12 and control signal S22 between logic high states and logic low states in a similar manner as previously discussed.

More specifically, during the first mode, when the controller 140-1 produces the control signal S12 applied to the gate node G31 to be a logic high state, the controller 140-1 produces the control signal S22 applied to the gate node GF2 to be a logic low state. Conversely, when the controller 140-1 produces the control signal S12 applied to the gate node G31 to be a logic low state, the controller 140-1 produces the control signal S22 applied to the gate node GF2 to be a logic high state.

Note that the switching frequency of controlling the gate nodes G31 and GF2 on and off between time T31 and time T41 is substantially greater than the line frequency (as defined by the period of the input voltage Vin between time T31 and time T51) associated with the input voltage Vin.

Between time T51 and time T61, between time T71 and time T81, etc., the controller 140 controls operation of the respective bidirectional switch circuitry 131-2 and bidirectional switch circuitry 132-2 in a similar manner as discussed above (the first mode) for the time duration between time T31 and time T41.

Between time T21 and time T31, between time T41 and time T51, between time T61 and time T71, etc., the controller 140 operates in a second mode (when the polarity of the input voltage Vin is negative).

During a second mode (when the polarity of the input voltage Vin is negative) such as between time T41 and time T51 in which the input voltage Vin between the node N1 and the node N2 is negative such as detected by the controller 140-1 or other suitable entity, the controller 140-1: i) produces the control signal S22 applied to the gate node GF2 to be a logic high between time T41 and time T51 and produces the control signal S12 supplied to the gate node G31 to be a logic high between time T41 and time T51, and ii) switches between generating the control signal S11 and control signal S21 between logic high states a logic low states.

More specifically, during the second mode, when the controller 140-1 produces the control signal S21 applied to the gate node G32 to be a logic high state, the controller 140-1 produces the control signal S11 applied to the gate node GF1 to be a logic low state. Conversely, when the controller 140-1 produces the control signal S21 applied to the gate node G32 to be a logic low state, the controller 140-1 produces the control signal S11 applied to the gate node GF1 to be a logic high state.

Note that the switching frequency of controlling the gate nodes G32 and GF1 on and off between time T41 and time T51 is substantially greater than the line frequency (as defined by the period of the input voltage Vin between time T31 and time T51) associated with the input voltage Vin.

Between time T21 and time T31, between time T61 and time T71, etc., the controller 140 controls operation of the respective bidirectional switch circuitry 131-2 and bidirectional switch circuitry 132-2 in a similar manner as discussed above (the first mode) for the time duration between time T41 and time T51. In other words, between time T21 and time T31, between time T41 and time T51, between time T61 and time T71, etc., the controller 140 operates in a second mode (when the polarity of the input voltage Vin is negative).

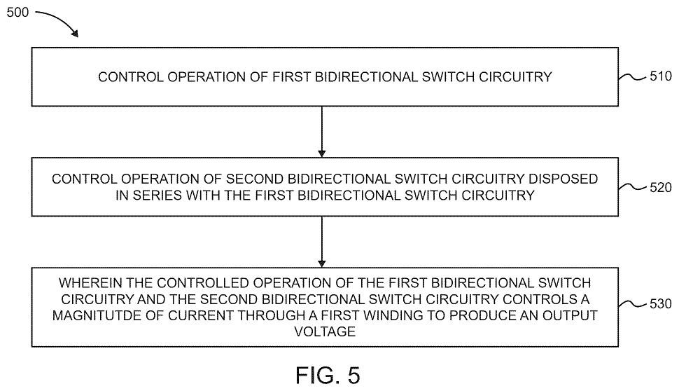

FIG. 5 is an example method of operating a respective power converter circuit including multiple instances of bidirectional switch circuitry to convert an input voltage into an output voltage as discussed herein.

In this example, in processing operation 510, the controller 140 of the power converter 100 controls operation of first bidirectional switch circuitry 131.

In processing operation 520, the controller 140 controls operation of second bidirectional switch circuitry 132 disposed in series with the first bidirectional switch circuitry 131.

In processing operation 530, via the controlled operation of the first bidirectional switch circuitry 131 and the second bidirectional switch circuitry 132, the controller 140 can be configured to control a magnitude of current 151 through the first winding 161-1 to produce an output voltage Vout supplied to the load 118.

Note again that techniques herein are well suited for use in power supply applications. However, it should be noted that examples herein are not limited to use in such applications and that the techniques discussed herein are well suited for other applications as well.

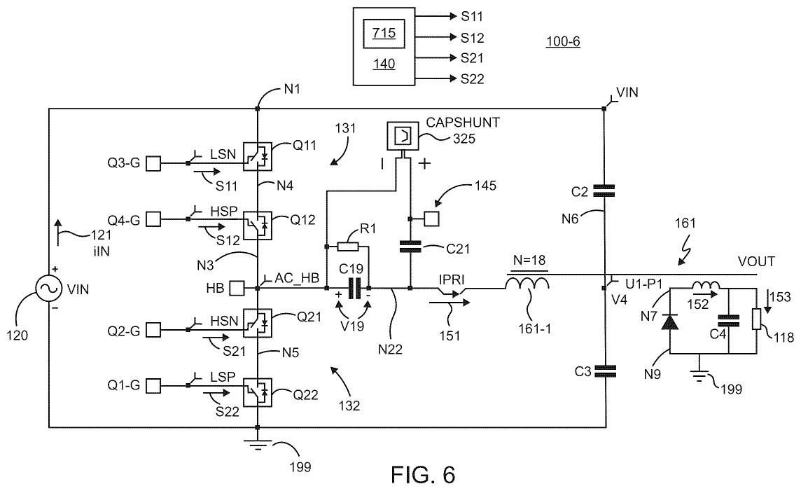

FIG. 6 is an example circuit diagram illustrating a power converter as discussed herein.

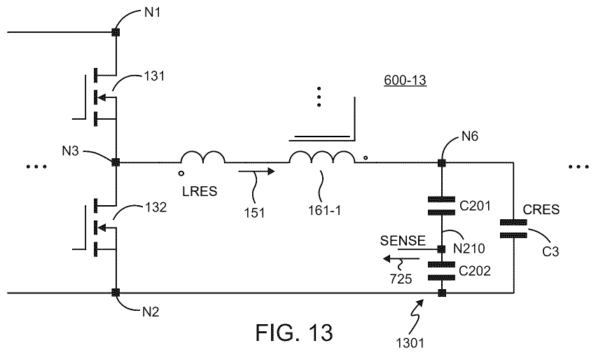

As previously discussed, note again that the implementation of the example circuits herein may vary depending on the application. For example, FIG. 6 illustrates a circuit example including bidirectional switches. Note that FIG. 13 to 15 illustrate a unidirectional circuit option of implementing techniques as discussed herein. Accordingly, the techniques herein can be implemented in unidirectional circuit options as well as bidirectional circuit options. In this case, signals LSN and HSP defined previously are merged into a single HS signal driving a unidirectional transistor. In the same way, LSP and HSN may be merged into a single LS signal.

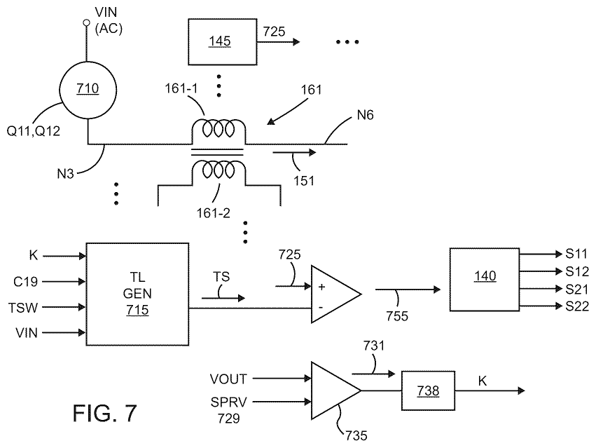

Additionally, note that the control concept as discussed herein using a generated threshold signal TS control may be referred to as a charge control technique such as based on dq or DeltaQ—because control may be implemented based on a difference of charge. For that, the circuitry as discussed herein can be configured to include generation of a shunt capacitor voltage (such as feedback 725) generated by a sense circuit 145 and the control threshold (such as threshold signal TS) generated by the threshold level generator 715 (such as an integrated circuit or semiconductor chip) as shown in FIG. 7.

In this example of FIG. 6, the power converter 100-6 includes a power source 120 (input voltage source), bidirectional switch circuitry 131, bidirectional switch circuitry 132, transformer 161, capacitor C1, capacitor C2, capacitor C3, capacitor C4, diode D1, and load 118.

The bidirectional switch circuitry 131 includes switch Q11 and switch Q12. The bidirectional switch circuitry 132 includes switch Q21 and switch Q22.

Note further that the circuitry 131 may include a single field effect transistor switch instead of multiple switches Q11 and Q12; the circuitry 132 may include a single field effect transistor switch instead of multiple switches Q21 and Q22. Thus it is not necessary to include bidirectional switch circuitry.

Transformer 161 includes primary winding 161-1 and secondary winding 161-2. The secondary winding 161-2 is magnetically coupled (inductively coupled) to the primary winding 161-1. In this example, a combination of the primary winding 161-1 and the capacitor C19 is connected in series between node N3 and node N6. The secondary winding 161-2 is connected between the node N7 and node N8.

The power source 120 providing the input voltage Vin (such as an AC voltage or input voltage Vin or input current 121) is connected between the node N1 and node N2. Accordingly, the voltage across the node N1 and node N2 is Vin.

Note further that the power converter 100-6 shown in FIG. 6 can be configured to include a controller 140 producing respective control signals.

In one example, the controller 140 produces the control signal S11 (a.k.a., LSN) to drive the gate node G of switch Q11. The control signal S11 is used to control the switch Q11 between an ON-state and an OFF-state.

The controller 140 produces the control signal S12 (a.k.a., HSP) to drive the gate node G of switch Q12. The control signal S12 is used to control the switch Q12 between an ON-state and an OFF-state.

The controller 140 produces the control signal S21 (a.k.a., HSN) to drive the gate node G of switch Q21. The control signal S21 is used to control the switch Q21 between an ON-state and an OFF-state.

The controller 140 produces the control signal S22 (a.k.a., LSP) to drive the gate node G of switch Q22. The control signal S22 is used to control the switch Q22 between an ON-state and an OFF-state.

It is noted that flow of current 151 (such as varying in magnitude) through the primary winding 161-1 causes a respective flow of current 152 through the secondary winding 161-2. The flow of current 152 through the secondary winding 161-2 produces the output voltage 123 (a.k.a., Vout) across the capacitor C4 and load 118.

Diode D1 prevents the current 152 from flowing in a negative direction through the secondary winding 161-2. In other words, the secondary current 152 through the secondary winding 161-2 flows in a direction from node N7 to node N8. Diode D1 prevents flow of current from node N7 through the diode D1 to the node N9.

Note that the power converter 100-6 in FIG. 6 is shown by way of nonlimiting example.

In this example, the power supply 100-6 includes the sense circuitry 145 such as including the capacitor C19, resistor R1, capacitor C21, and switch 325.

The sense circuit 145 is configured to sense first power supplied from the input voltage Vin through the first transformer winding 161-1 to a second transformer winding 161-2. As previously discussed, the second transformer winding 161-2 is magnetically coupled to the first transformer winding 161-1.

As further discussed herein, the controller 140 and switch circuitry (Q11, Q12, Q21, and Q22) collectively provide power factor correction associated with conversion of the input voltage Vin into an output voltage Vout outputted from an output of the second transformer winding 161-2 to the load 118.

The power factor correction as discussed herein can be configured to control a flow of the first power (and corresponding magnitude) from the input voltage Vin through the first transformer winding 161-1.

Additional details of implementing the sense circuitry 145 and corresponding control of the respective switches to provide power factor correction is discussed in the following drawings and corresponding descriptive text.

FIG. 7 is an example circuit diagram illustrating implementation of a power converter and corresponding control as discussed herein.

In this example, any of the power converters as discussed herein include respective switch circuitry 710 (such as switch Q11, switch Q12, etc.) to control a respective magnitude of current (and thus power P1) supplied from the input voltage Vin to the transformer winding 161-1.

As previously discussed, the transformer winding 161-2 is magnetically coupled to the transformer winding 161-1 to receive the power P1 from the transformer winding 161-1. In other words, the transformer 161 facilitates conveyance of the power P1 from the transformer winding 161-1 to the transformer winding 161-2. The energy P1 received by the secondary transformer winding 161-2 is used as a basis in which to produce the output voltage supplying power P2 to the load 118. Techniques herein include power factor correction and substantial equalization of an average of the power P1 and an average of the power P2.

Further in this example, note that the controller 140 or other suitable entity can be configured to include circuitry to control conveyance of the current 151 through the corresponding winding 161-1 based on use of a respective control signal (threshold signal TS) generated by the threshold level generator 715. The current 151 may or may not pass through the sense circuitry 145.

As further shown, note that the circuitry as discussed herein can be configured to include one or more of an error voltage signal generator 735, filter function 738, threshold level generator 715, and comparator 720.

As shown in this example, the error voltage signal generator 735 produces the respective error signal 731 (such as error voltage, error current, etc.) based on a difference between a magnitude of the output voltage Vout and the setpoint reference voltage 729. In one example, the setpoint reference voltage 729 represents the target magnitude value in which the controller 140 regulates the magnitude of the output voltage Vout via implementation of the control signal (threshold signal TS) produced by the generator 715.

Yet further, note that the filter function 738 such as a PID (where P=Proportional, I=Integral, D=Derivative) controller, PI controller, or other suitable entity, converts the received error signal 731 into the signal K (such as filtered error signal) supplied to the threshold level generator 715.

The threshold level generator 715 receives the signal K, capacitance C associated with the sense circuit 145, the switching period Tsw associated with operating the respective switches 710, and the input voltage Vin.

In one example, the controller 140 and/or corresponding circuitry associated with the controller 140 produces the control threshold signal, TS, as follows:
setting the threshold signal TS=OSV−[(tsw1/(K*C))*Vin]−cmp, (note that K can be located at denominator or nominator depending on whether a PID is built consequently. The minus sign can also be positive depending on the configuration of the sense. In other words, if sense reference is not AC_HB, but capacitor C19 instead—(see FIG. 6).
where OSV is a selected offset value, note that OSV can be negative, positive, or zero. In one example, OSV is constant for one switching cycle (not AC), but may vary otherwise over time.
where the switching period, Tsw1, is a measure of a period of controlling the switch circuitry around the time of generating the corresponding threshold signal TS, the switching period may be generated based upon one or more current or prior switching periods of controlling the switches or potentially may be based on the current switching period of controlling the switches in the current control cycle,
where C is the capacitance associated with the sense circuitry 145 (there are one of more different configurations associated with the sense circuitry 145. For some configuration C is an equivalent capacitance to the shunt capacitor),
where K is the feedback (filtered error voltage value), and
where Vin is the sample instance of the magnitude of the input voltage around the time of generating the corresponding threshold signal TS.
Where cmp is an optional compensation factor against currents induced by the AC line (input voltage) in the sense circuitry. In one example, the line current (@50/60 Hz) from the input voltage flows through capacitors C91 and C92, which disrupts the sense network. Part of this current is considered transferred to the secondary side by sense network when it only circulates locally. Compensation cmp improves power factors. Compensation (Cmp) may be proportional to dVin/dt.

As further shown, the comparator 720 is used to produce the trigger signal 755, which is used (by the controller 140) as a basis in which to terminate activation of one or more of the switches Q11 and Q12 during a positive cycle when the input voltage is greater than 0, or terminate activation of one or more of the switches Q21 and Q22 during a negative cycle when the input voltage is less than 0, both operations of which limit the magnitude of the power supplied by the input voltage Vin to the transformer winding 161-1 to provide power factor correction.

In one example, in response to the comparator 720 detecting transition of the feedback (indicating power P1 such as based on integration of current) crossing the respective threshold signal TS, the comparator 720 produces the respective trigger signal 755. As further discussed herein, the trigger signal 755 can be used as a basis in which to terminate activation of the respective switch circuitry 710 such that the input voltage Vin no longer supplies corresponding power P1 to the transformer winding 161-1.

Accordingly, the controller 140 and corresponding sense circuit 145 as discussed herein can be configured to collectively: i) monitor a magnitude of the first power (integration of current 151) via feedback 725 (signal) from the sense circuit 145, and ii) provide power factor correction via controlled operation of the switch circuitry (Q11 and Q12) such that an average magnitude of the first power P1 supplied from the input voltage Vin to the first transformer winding 161-1 over time is substantially equal to an average magnitude of the second power P2 supplied from the second transformer winding 161-2 to the respective load 118.

Referring again to FIG. 6, the circuit path between node N3 and node N6 can be configured to include a first capacitor C19 coupled in series with the first transformer winding 161-1. The controller 140 is operative to, via control of the switch circuitry, control a flow of resonant current through the series circuit path. The controlled flow of the resonant current is operative to provide the power factor correction as discussed herein.

Further in this example, the sense circuitry 145 includes a series circuit path including a capacitor C21 disposed in series with switch 325, where the series circuit path (combination of C21 and switch 325) is disposed in parallel with the capacitor C19.

Yet further in this example, as previously discussed, the sense circuit 145 includes a sensing capacitor C19 disposed in series with the first transformer winding 161-1 to sense the first number of charges (or quantity or magnitude of charge) supplied from the input voltage Vin to the first transformer winding 161-1. Note that the shunt capacitor may not sense power—it produces an arithmetic sum of the amount of charges that flows through it (i.e., the capacitor integrates based on the current through it). The sensing capacitor C19 is initially set to an initial state such as 0 volts or other suitable value for a measuring phase of monitoring a magnitude of the power P1. The output voltage Vout is generated by the secondary stage of the power supply 100-6 based on the power received by the transformer winding 161-2 (i.e., the second transformer winding 1 6102 receives the power from the first transformer winding 161-1). The second transformer winding 161-2 uses the received power P1 to generate the output voltage Vout outputted to power the load 118. The load 118 consumes power P2.

Examples herein include controlling the magnitude of the power inputted to the first winding 161-1 and transferred to the second winding 161-2 to provide power factor correction. For example, the sense circuit 145 produces a respective feedback signal 725 (a.k.a., such as voltage V19 across the capacitor C19). The controller 140: i) monitors a magnitude of a voltage (such as feedback 725) across the capacitor C19 to determine a magnitude of power P1 supplied to the transformer winding 161-1, and ii) controls operation of the switch circuitry (switch Q11 switch Q12 and switch Q21 and switch Q22) such that an average magnitude of the first power conveyed from the winding 161-1 to the winding 161-2 over multiple control cycles is substantially equal to an average magnitude of the second power consumed by the respective dynamic load 118 over the multiple control cycles. In other words, on average, the magnitude of the power supplied to the transformer winding 161-1 and conveyed to the second transformer winding 161-2 should generally be equal to the magnitude of power supplied by the secondary winding 161-2 and consumed by the load 118.

As previously discussed, by way of non-limiting example, the sense circuit 145 includes a sense capacitor C19 operative to store a voltage value (a.k.a., feedback 725) indicating an integral of current 151 (also indicating power) supplied through the first transformer winding 161-1.

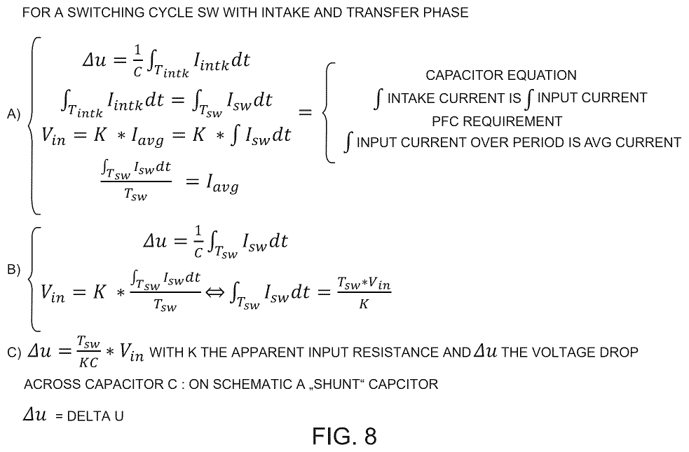

As further discussed below, the threshold level signal generator circuit 715 produces the threshold signal TS (threshold level) based on one or more parameters such as signal K, capacitance associated with the sun circuit 145, switching Tsw, and magnitude of the input voltage Vin. The controller 140 controls the switch circuitry based on the threshold signal TS to provide the power factor correction. Details associated with generating the threshold signal TS is further discuss in FIG. 8.

FIG. 8 is an example diagram illustrating derivation of a control method as discussed herein.

In this example, the threshold signal TL (threshold value such as [Tsw/(K*C)]*Vin) is derived based on multiple received values such as input voltage Vin, switch period Tsw, filtered error signal K, and capacitance C associated with the sense circuit 145.

The link between average cycle current and resonant capacitor and delta V as discussed herein is useful.

As previously discussed, a comparator 720 (and corresponding threshold signal TS and feedback 725) may be used to determine the exact point of time where iPRI or input current 121 (or current 151) and corresponding first power P1 supplied to the transformer winding 161-1 has reached a certain threshold level. In one example, the average of the current 151 is integrated over time via the respective sense circuit 145 to detect the first power P1 supplied by the input voltage Vin to the transformer winding 161-1.

In one example, real control is based on stored charge q, representing a magnitude of charge transferred; and charge transferred during a duration is average current.

In a further example, if the input current iPRI is kept proportional to the input voltage, the input behaves like a PFC (Power Factor Correction).

This is an example definition of a PFC: if iIPRI=k*Vin, then it is a PFC.

The only thing that remain is to control delta V to be proportional to Vin.

For example, delta u=Δu=T_sw/KC*V_in the PFC requirement are met.
Tsw is the switching period
In one example, signal K is a scaling factor representing the system load resistance C is the equivalent capacitance of the sense network associated with the sense circuit 145
For a closed loop control, K can be used as feedback input
Any regulators (PI, PID, P . . . ) or filters (such as Ikow pass, notch, . . . ) 738 with low gain at AC frequency such as around 50 to 100 hertz can be used to produce the signal K

The input voltage Vin inputted to the threshold signal generator 715 may be measured on the fly (instantaneous voltage) because the input voltage Vin varies over time, the magnitude of the first power stored in the transformer winding 161-1 over time depends upon the magnitude of the input voltage Vin (such as a sine wave).

Tsw can be generated and/or measured using any suitable circuit such as a so-called bang bang circuit determining a most recent magnitude of the switch cycle or last value, slope (actual value of current cycle), etc.

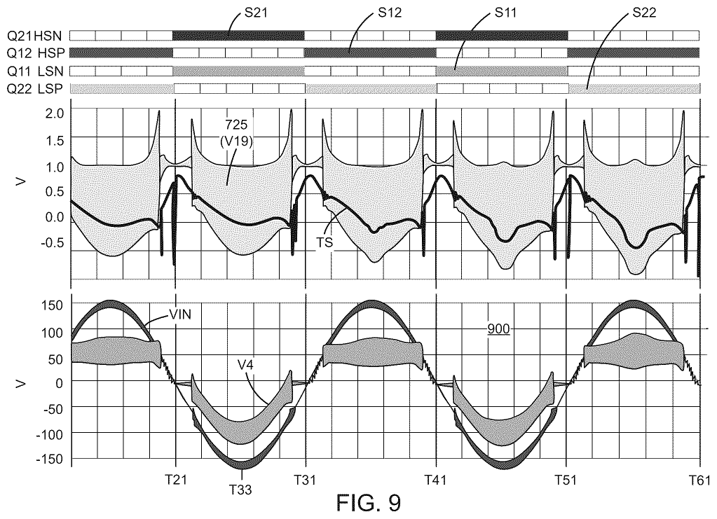

FIG. 9 is a timing diagram illustrating control of a respective power converter over multiple AC input voltage cycles as discussed herein.

As shown in timing diagram 800, the input voltage Vin is substantially a sine wave (AC signal or Alternating Current or Alternating Voltage), where the input voltage Vin is positive in polarity between time T31 and time T41, between time T51 and time T61, and so on. The input voltage Vin is negative in polarity between time T21 and time T31, between time T41 and time T51, and so on.

Voltage V4 is the voltage at node N6.

Signal S21 (HSN) controls operation of the switch Q21; signal S12 (HSP) controls operation of the switch Q12; signal S11 (LSN) controls operation of the switch Q11; and signal S22 (LSP) controls operation of the switch Q22.

When the input voltage Vin is positive polarity: The controller 140 produces the control signal S11 to be a logic high to activate the corresponding switch Q11. The controller 140 also produces the control signal S21 to be a logic high to activate the switch Q21. Via signal S12 and signal S22, the controller 140 alternatingly switches between activating the switch Q12 and the switch Q22. As discussed herein, the switches Q21 and Q22 are controlled to supply a desired amount of power from the input voltage Vin through the transformer winding 161-1 to provide power factor correction.

When the input voltage is negative polarity: The controller 140 produces the control signal S12 to be a logic high to activate the corresponding switch Q12. The controller 140 also produces the control signal S22 to be a logic high to activate the switch Q22. Via signal S11 and signal S21, the controller 140 alternatingly switches between activating the switch Q11 and the switch Q21. As discussed herein, the switches Q11 and Q21 are controlled to supply a desired amount of power from the input voltage Vin through the transformer winding 161-1.

As previously discussed, the feedback 725 is produced by the sense circuit 145 (monitor circuit) monitoring a magnitude of current 151 (and thus power) supplied to the transformer winding 161-1.

As further shown, and as previously discussed, the timing diagram 900 also illustrates how the magnitude of the threshold signal TL varies over time to provide power factor correction. For example, as previously discussed, the controller 140 receives the feedback signal 725 (shown as an envelope and timing diagram 900) from the sense circuit 145. Via comparison of the feedback signal 725 to the threshold signal TL (a.k.a., control signal), the controller 140 provides the power factor correction based on controlled operation of the switch circuitry. In one example, the controlled operation of the switch circuitry results in an average magnitude of the first power (as indicated by the sense circuit 145) supplied from the input voltage Vin to the first transformer winding 161-1 being substantially equal to an average magnitude of the second power (such as based on output current as supplied by the output voltage Vout) outputted from the second transformer winding 161-2 to the respective load 118.

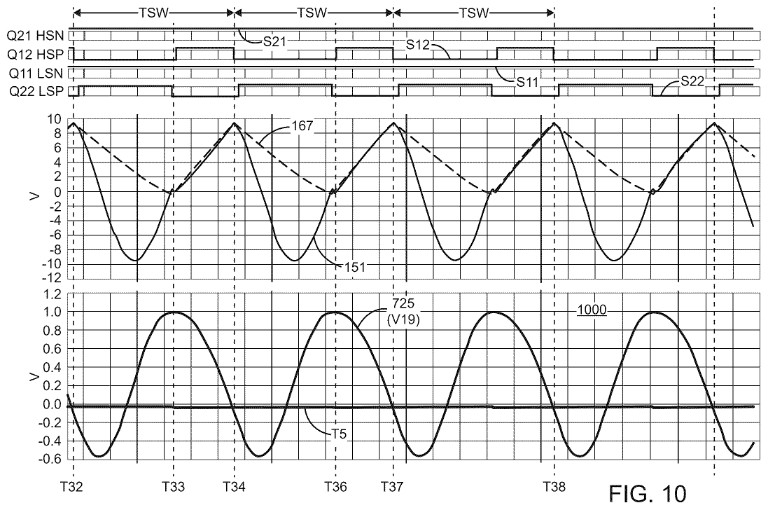

FIG. 10 is an example timing diagram illustrating control of a respective power converter as discussed herein.

In this example, at time T33 in timing diagram 1000, the controller 140 or other suitable entity pre-charges the voltage of the shunt capacitor C19 (associated with the sense circuitry 145) to a known value. Any suitable pre-charge value can be used, which may include shorting the node N22 to node N3.

As shown in timing diagram 1000, because the magnitude of the AC input voltage Vin is positive, the controller 140 activates both of the switches Q11 and Q21 to an ON-state. The controller 140 alternatingly switches between activating the switch Q12 and the switch Q22 to provide power factor correction as discussed herein.

Between time T32 and time T33, the controller 140 sets the switch Q22 to an ON-state and switch Q12 to an OFF-state. In such an instance, the energy stored in the transformer winding 161-1 is discharged based upon generation of the output voltage Vout. In other words, the energy in the transformer 161-1 decreases.

Just after or around time T33, the controller 140 produces the control signal S12 to activate the switch Q12 to an ON-state. The controller 140 produces the control signal S22 to deactivate the switch Q22 to an OFF-state. Thus, at or around time T33, energy intake (of energy into the transformer winding 161-1) starts in which a magnitude of the current 151 supplied from the input voltage Vin through the capacitor C19 and the transformer winding 161-1 increases.

Note that the primary current is also magnetizing current 167 since the transformer 161 is used as an inductor.

Due to the increased flow of current 151 (resonant current) from the input voltage source 120 through the combination of switch Q11 and switch Q12, and capacitor C19, and transformer winding 161-1, starting at time T33, the voltage V19 (feedback 725) across the shunt capacitor C19 falls from the original pre-charged value of 1 volt or other suitable value. In other words, the magnitude of the feedback signal 725 decreases in proportion to an amount of the first energy stored in the transformer winding 161-1.

As previously discussed, the sense circuitry 145 (FIG. 7) and corresponding controller 140 implement the comparator 720 to compare the feedback 725 (or voltage V19 from capacitor C19) to the threshold signal TS as generated by the threshold level generator 715. When the comparator 720 detects that the magnitude of the feedback 725 falls below the threshold signal TS (such as −40 mV or other suitable magnitude below the pre-charge voltage) at or around time T34, the comparator 720 produces the trigger signal 755 notifying the controller 140 of the trigger event (magnitude of the feedback 725 falls below the threshold signal TS). In response to this trigger event as indicated by the trigger signal 755, the controller 140 deactivates the switch Q12 and activates the switch Q22 at or around time T34.

Deactivation of the switch Q12 at or around time T34 ends the energy intake phase (such as energy received from the input voltage Vin to the transformer winding 161-1) and starts the energy transfer phase (energy in transformer winding 161-1 transferred to the transformer winding 161-2 to generate a corresponding output voltage Vout).

Due to the blocking capacitors C2 and C3, most of the current that flows out of the shunt capacitor is flowing back inside. At the end (such as around time T36) of the energy transfer cycle (where the cycle is between time T33 and time T36), the voltage V19 across the shunt capacitor C19 is almost back at the pre-charge value of around 1 volt.

In one example, the resistor R1 provides drift cancellation with respect to the capacitor C19, although any suitable drift capacitor circuit can be used.

Accordingly, one concept as discussed herein is that the voltage V19 (such as feedback 725) can be used to determine delta Q, which can be translated into an average of current 151 and corresponding first energy during intake (such as between time T33 and time T34) and (for a hybrid flyback) also to an average current during a period (Tsw) such as between time T33 and time T36. The power converter as discussed herein can be configured to match average current and average voltage during one switching period through a constant (feedback dependent with no gain at 50/60 Hz) resulting in power factor correction.

Thus, the feedback 725 (the high frequency signal with respect to the frequency of the input voltage Vin) generated by the sense circuitry 145 is a sense signal used for DeltaQ control. The threshold signal TS is the threshold against which the signal 725 is compared. When both are identical (crossing) as detected by the comparator 720, the controller 140 terminates intake of energy from the input voltage Vin to the transformer winding 161-1 at or around times T34, T37, T38, etc.). DeltaQ can be above and below the threshold, especially during the energy transfer phase.

It is further noted that a magnitude of the feedback signal 725 may be directly proportional to a magnitude of the energy transferred from the input voltage Vin to the transformer winding 161-1 in which the magnitude of the feedback signal 725 is configured to increase over time instead of decrease over time. In such an instance, the comparator 720 or other suitable entity can be configured to generate the trigger signal 755 in response to detecting that the magnitude of the feedback signal 725 is greater than the threshold signal TS.

Accordingly, as previously discussed, the controller 140 as discussed herein can be configured to continuously adjust (on an as needed basis, one cycle after another) the operation of the switch circuitry (i.e., Q11, Q12, Q21, Q22) via producing a threshold signal, TS, based on at least the magnitude of the output voltage Vout and potentially other parameters. The comparator 720 compares the feedback signal 725 (indicative of the magnitude of the first energy conveyed to the transformer winding 161-1) generated by the sense circuit 145 to the threshold signal TS. Based on the comparing and detecting a trigger event such as the magnitude of the feedback signal 725 falling below the threshold signal TS, the controller 140 operates the switch circuitry to terminate flow of the first current 151 through the first transformer winding 161-1.

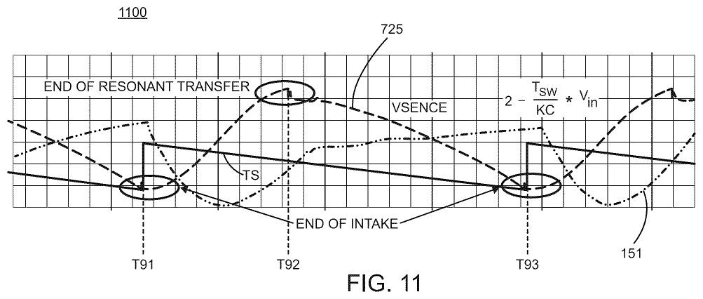

In one example, a magnitude of the threshold signal, TS, varies over time. Another example of this is more particularly shown in FIG. 11.

Referring again to FIG. 10, and as previously discussed, the threshold level signal generator 715 can be configured to produce the threshold signal, TS, based on a combination of one or more of: i) a magnitude of the input voltage Vin, ii) a capacitance CSC associated with sense circuitry 145 producing the feedback signal 725, iii) filtered error voltage signal K derived based on a difference between a magnitude of the output voltage Vout and a setpoint reference voltage 729 (i.e., the filtered error voltage signal K is derived by the error voltage signal generator 785 based the error signal 736 generated based on a difference between magnitude of the output voltage Vout and the setpoint reference voltage 729), and iv) the switching period Tsw of operating the respective switch circuitry.

Note that the switching frequency associated with generating the respective control signals S11, S12, S21, and S22 may vary over time. As previously discussed, the duty cycle associated with activating the respective high side switch circuitry Q12 may vary over time as well based upon the magnitude of the threshold signal TS (threshold level that varies to provide control and power factor correction).

In one example, as previously discussed, in response to detecting that the magnitude of the feedback signal 725 falls below the threshold level TS, the controller 140 sets the respective switch Q12 to an off state such that the input current iIN from the voltage source 120 no longer flows through the switches and through the transformer winding 161-1 (a magnitude of current 151 stops increasing). The residual energy stored in the primary winding 161-1 transfers to the secondary transformer winding 161-2 to produce the output voltage Vout.

As previously discussed, the threshold signal TS may be changing slowly with a dependency on input voltage (Vin) and compensate at the same time for a change in period (Tsw).

In one example, the offset value OSV associated with the threshold signal TS is used to keep the value TS within range of the comparator 720. In other words, the offset OSV may be implemented to prevent the threshold signal TS (threshold level) from exceeding the comparator (720) rails (1V in sim, no effect on control), where the value K is feedback input (for example, it may be equivalent input resistance enforced by control—changing it changes average energy intake) and capacitance C is the sense capacitor network gain in coulomb.

FIG. 11 is an example timing diagram illustrating control of a respective power converter as discussed herein.

Timing diagram 1100 illustrates an example of sence voltage (Vsence or feedback 725 generated by the sense circuit 145) and delta U control. In this example, the voltage Vsence (a.k.a., feedback 725) is the sense voltage feedback generated by a shunt capacitor or a capacitive divider circuit (such as sense circuit 145) monitoring a magnitude of the current 151 or energy supplied to or through the primary winding 161-1.

In one example, at the beginning of the intake (a.k.a., end of transfer) such as around time T92, the voltage signal Vsense and corresponding sense circuit 145 are initialized to a known value.

Note that there may be some drift of initial condition (pre-charge) associated with the sense circuit 145, which is to be expected. Without the resetting of the sense circuit 145 and corresponding capacitors, the U1 value will be lost over time.

As further shown, a next cycle is started when (such as time T91, time T93, etc.) Vsense (feedback 725) equals or crosses or falls below the threshold control line (threshold signal TS) at voltage U2. For convenience, as previously discussed, an offset OSV can be added to the control signal (TS). The offset value OSV associated with the threshold signal TS has no impact on Delta U as the offset cancels out. As previously discussed, the use of the offset value OSV alleviates the need for an extra set of comparator voltage rails to operate the comparator 720.

Thus, the timing diagram 1100 in FIG. 11 illustrates how the magnitude of the threshold signal TS varies over time from one cycle to the next as well as how the magnitude of the feedback 725 produces the respective trigger signal of starting a new cycle as previously discussed.

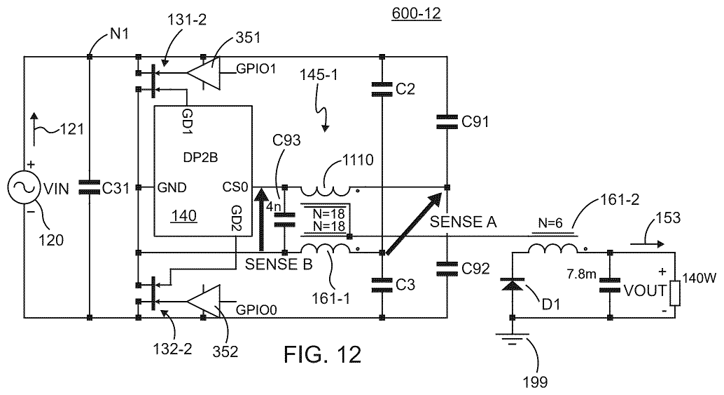

FIG. 12 is an example circuit diagram illustrating a power converter circuit and corresponding primary winding power/energy flow sensing as discussed herein.

Depending on control position, as shown in the power supply 600-12, an extra winding 1110 and the capacitor C93 can be implemented to bring the sense voltage (feedback signal 725 generated by the sense circuit 145-1) to the same reference as the controller 140. This may be useful for bridgeless HBF (hybrid flyback) configurations due to the floating placement of the controller 140.

FIG. 13 is an example diagram illustrating a sense circuit configured to monitor a magnitude of current (first energy) through a respective primary transformer winding as discussed herein.

In this example, the power supply 600-13 is substantially identical to the power supply 600 as previously discussed. However, the controller 140 controls operation of the switches 131 and 132 to convey the first energy from the input voltage Vin (from node N1) to the first transformer winding 161-1 magnetically coupled to the transformer winding 161-2.

The sense circuit 1301 (such as a capacitor divider circuit) in this example is implemented to monitor a magnitude of the energy supplied to the transformer winding 161-1 includes multiple capacitors C201 and C202 disposed in series between the node N6 and the node N2. The combination of the capacitors C201 and C202 are disposed in parallel with the resonant capacitor C3.

Further in this example, the node N210 coupling the capacitor C201 and C202 produces the respective feedback signal 725 indicative of a magnitude of the first energy P1 supplied to the transformer winding 161-1 via control of the switches 131 and 132.

In one example, as previously discussed, the power supply 600 (and any corresponding instantiations such as 600-1, 600-2, 600-3, etc.) are implemented as flyback power converters operating in a resonance mode via controlled switching of respective switches 131 and 132 as implemented by the controller 140.

In one example, the controller 140 controls flow of the first energy P1 through the first winding 161-1 by controlling resonant current (such as current 151) flowing from the input voltage Vin through the first transformer winding 161-1. As discussed herein, the controlled flow of the resonant current (such as current 151) through the first transformer winding 161-1 provides power factor correction such that an average magnitude (such as over one or more cycles of the input voltage) of the first energy supplied from the input voltage to the first transformer winding is substantially equal to an average magnitude of the second energy supplied from the second winding to the respective load.

Thus, the charge control through the transformer winding 161-1 and power factor correction as discussed herein is an option for implementing any resonant power converter topology to link resonant capacitor voltage to the transfer of energy from one transformer winding 161-1 to the transformer winding 161-2.

During the high side ON time (such as activation of switch 131), the voltage difference across the capacitor is proportional to the input current.

$$Δ u = U\_end - U\_start = 1 / C {\int }_{-} ( T\_intk ) \hat{} ▯I\_intk dt ▯ = I\_avg / C$$

By controlling deltaV across the resonant capacitor C3, the average input current is controlled, providing most of the advantage of current mode control with resilience against reactive/circulating current.

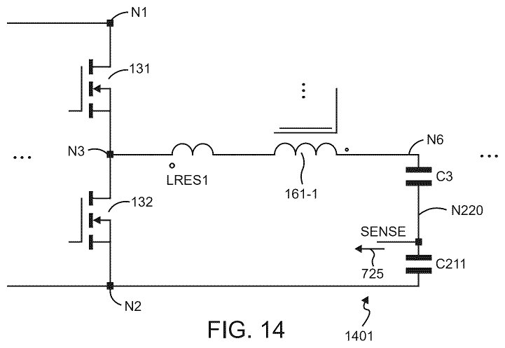

FIG. 14 is an example diagram illustrating a sense circuit configured to monitor a magnitude of current (first energy) through a respective primary transformer winding as discussed herein.

In this example, the power supply 600-14 is substantially identical to the power supply 600 as previously discussed. In this example, however the controller 140 controls operation of the switches 131 and 132 to convey the first energy from the input voltage Vin to the first transformer winding 161-1 magnetically coupled to the transformer winding 161-2.

The sense circuit 1401 (such as via a shunt capacitor sensing circuit) is implemented to monitor a magnitude of the energy supplied to the transformer winding 161-1 includes capacitor C211 disposed in series with the capacitor C3 between the node N6 and the node N2. The node N220 coupling the capacitor C3 and C211 produces the respective energy feedback signal (such as feedback 725) indicative of a magnitude of the corresponding first energy supplied by the input voltage Vin to the transformer winding 161-1 via control of the switches 131 and 132.

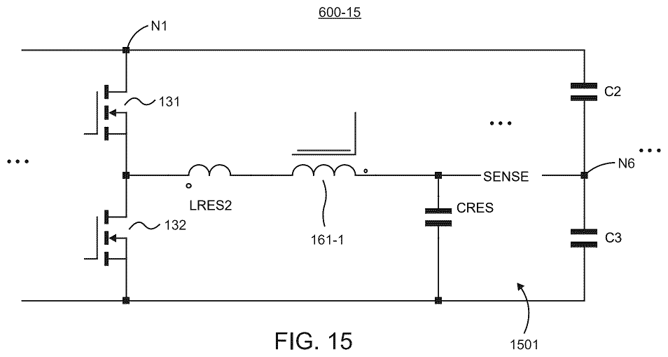

FIG. 15 is an example diagram illustrating a sense circuit configured to monitor a magnitude of current (first energy) through a respective primary transformer winding as discussed herein.

In this example, the power supply 600-15 is substantially identical to the power supply 600 as previously discussed. In this example, however, the controller 140 controls operation of the switches 131 and 132 to convey the first energy from the input voltage Vin to the first transformer winding 161-1 magnetically coupled to the transformer winding 161-2.

As shown, the sense circuit 1501 (such as via a floating reference sensing circuit) is implemented to monitor a magnitude of the power supply 600-3 to the transformer winding 161-1.

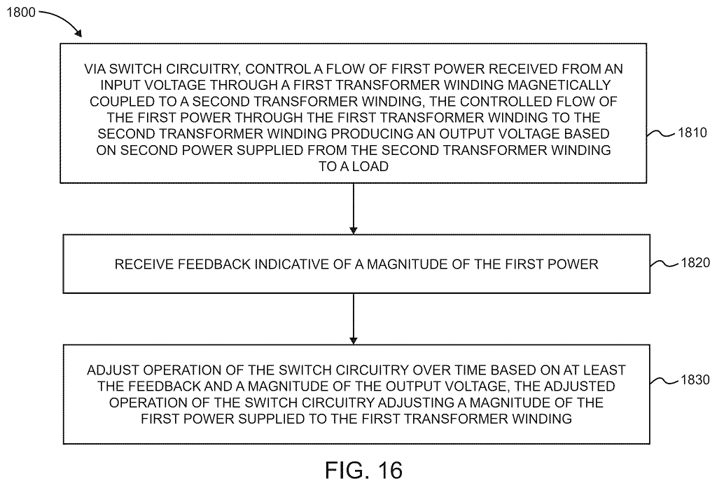

FIG. 16 is an example method of controlling a respective resonant power converter to provide power factor correction as discussed herein.

In processing operation 1810, via control of switch circuitry such as switches Q11, Q12, Q21, Q22, the controller 140 controls a flow of first energy (such as based on resonant current 151 or iPRI) received from an input voltage Vin and conveyed through a first transformer winding 161-1 magnetically coupled to a second transformer winding 161-2. The controlled flow of the first energy (such as resonant current 151) through the first transformer winding 161-1 to the second transformer winding 161-2 results in generation of an output voltage Vout based on second energy (first power converter to the second energy) supplied from the second transformer winding 161-2 to a load 118.

In processing operation 1820, the controller 140 receives feedback such as 725 (such as a voltage V19 across the capacitor C19 or feedback from any of the different sense circuitry 145 as discussed herein). In one example, the feedback 725 multiplied by the input voltage is indicative of a magnitude of the first energy conveyed through the first windings 161-1 for a time duration such as between time T33 and time T34.

In processing operation 1830, the controller 140 adjusts operation of the switch circuitry (switches Q11, Q12, Q21, Q22) over time based on at least the feedback (indicating first energy P1) and a magnitude of the output voltage Vout. The adjusted operation of the switch circuitry such as termination of activating the highside switch circuitry Q12) adjusts a magnitude of the first energy P1 supplied each cycle to the first transformer winding 161-1. More specifically, the activation of switch circuitry at time T34 as previously discussed prevents further energy P1 from being supplied to the transformer winding 161-1.

In one example, as previously discussed, the controlled flow of the first energy through the first winding 161-1 includes controlling resonant current (such as current 151) flowing from the input voltage Vin through the first transformer winding 161-1. The controlled flow of the resonant current through the first transformer winding provides power factor correction associated with conversion of the input voltage Vin into the output voltage Vout through the flyback power converter configuration as shown in the power converter 600 and other power converters as previously discussed.

Note again that techniques herein are well suited for use in power supply applications. However, it should be noted that examples herein are not limited to use in such applications and that the techniques discussed herein are well suited for other applications as well.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

1. An apparatus comprising:
a first transformer winding;
sense circuitry operative to sense first energy supplied from an input voltage to the first transformer winding; and
switch circuitry operative to apply power factor correction associated with conversion of the input voltage into an output voltage derived from an output of a second transformer magnetically coupled to the first transformer winding, the applied power factor correction operative to control a flow of the first energy from the input voltage to the first transformer winding.

2. The apparatus as in claim 1, wherein the output voltage is operative to supply second energy to a respective load, the apparatus further comprising:
a controller operative to: i) monitor a magnitude of the first energy via feedback from the sense circuitry, and ii) apply the power factor correction via controlled operation of the switch circuitry such that an average magnitude of the first energy supplied from the input voltage to the first transformer winding is substantially equal to an average magnitude of the second energy supplied from the second transformer winding to the respective load.

3. The apparatus as in claim 1, wherein the sense circuitry includes a first capacitor, the apparatus further comprising:
a series circuit path including the first capacitor coupled in series with the first transformer winding.

4. The apparatus as in claim 3 further comprising:
a controller operative to, via control of the switch circuitry, control a flow of resonant current through the series circuit path, the flow of resonant current controlled based on the applied power factor correction.

5. The apparatus as in claim 1, wherein the sense circuitry includes a capacitor operative to sense a magnitude of the first energy supplied from the input voltage through the switch circuitry to the first transformer winding.

6. The apparatus as in claim 5, wherein the output voltage derived from the output of the second transformer winding is operative to supply second energy to a respective load, the apparatus further comprising:
a controller operative to: i) monitor feedback received from the sense circuitry, the feedback indicating the magnitude of the first energy, and ii) via the power factor correction, control operation of the switch circuitry such that an average magnitude of the first energy over multiple control cycles is substantially equal to an average magnitude of the second energy over the multiple control cycles.

7. The apparatus as in claim 1, wherein the sense circuitry includes a series circuit path including a first capacitor disposed in series with a first switch, the series circuit path disposed in parallel with the first transformer winding.

8. The apparatus as in claim 1, wherein the sense circuitry includes a sense capacitor operative to store a voltage value indicating an integral of current supplied by the input voltage through the first transformer winding.

9. The apparatus as in claim 1 further comprising:
a signal generator circuit operative to produce a threshold signal based at least in part on a magnitude of the output voltage with respect to a setpoint reference voltage; and
a controller operative to control the switch circuitry and the flow of the first energy from the input voltage to the first transformer winding based upon the threshold signal to apply the power factor correction.

10. An apparatus comprising:
a controller operative to:
via control of switch circuitry, control a flow of first energy received from an input voltage through a first transformer winding magnetically coupled to a second transformer winding, the controlled flow of the first energy through the first transformer winding to the second transformer winding operative to produce an output voltage based on second energy supplied from an output of the second transformer winding to a load;
receive feedback indicative of a magnitude of the first energy; and
adjust operation of the switch circuitry over time based on at least the feedback and a magnitude of the output voltage, the adjusted operation of the switch circuitry operative to adjust a magnitude of the first energy supplied to the first transformer winding.

11. A method comprising:
via switch circuitry, controlling a flow of first energy received from an input voltage through a first transformer winding, the first transformer winding magnetically coupled to a second transformer winding, the controlled flow of the first energy through the first transformer winding to the second transformer winding producing an output voltage based on second energy supplied from an output of the second transformer winding to a load;
receiving feedback indicative of a magnitude of the first energy; and
applying power factor correction via control of the switch circuitry over time based on at least the received feedback and a magnitude of the output voltage, the control of the switch circuitry including adjustment of a magnitude of the first energy supplied to the first transformer winding.

12. The method as in claim 11, wherein controlling the flow of the first energy includes controlling resonant current supplied by the input voltage through the first transformer winding.

13. The method as in claim 11, wherein the control of the switch circuitry over time substantially equalizes an average magnitude of the first energy and an average magnitude of the second energy.

14. The method as in claim 11, wherein the control of the switch circuitry over time includes:
adjusting operation of the switch circuitry over time based on one or more of: i) the feedback indicative of the magnitude of the first energy, ii) the magnitude of the output voltage, iii) a magnitude of the input voltage, iv) a capacitance associated with sense circuitry producing the feedback, and iv) a switching period of controlling the switch circuitry.

15. The method as in claim 11, wherein the control of the switch circuitry includes:
producing a threshold signal;
comparing the feedback indicative of the magnitude of the first energy to the threshold signal; and
terminating flow of first current through the first transformer winding based on the comparing.

16. The method as in claim 15, wherein a magnitude of the threshold signal varies over time based on a magnitude of the input voltage.

17. The method as in claim 15 further comprising:
producing the threshold signal based on a combination of:
i) the magnitude of the output voltage with respect to a setpoint reference voltage,
ii) a magnitude of the input voltage, and
iii) a capacitance associated with sense circuitry producing the feedback.

18. The method as in claim 15, wherein the threshold signal is threshold signal TS;
wherein producing the threshold signal TS includes:
setting the threshold signal TS=OSV−[(tsw1/(K*C))*Vin]−cmp,
where OSV is an offset value,
where tsw1 is a measure of a period of controlling the switch circuitry,
where C is a capacitance associated with sense circuitry producing the feedback,
where K is based on an error voltage derived from comparing the magnitude of the output voltage to a setpoint reference voltage,
where Vin is the magnitude of the input voltage, and
where cmp is an optional compensation factor against currents induced by the input voltage in the sense circuitry.

19. The method as in claim 11 further comprising:
receiving the feedback from sense circuitry, the feedback generated by the sense circuitry based on integration of a magnitude of first current supplied from the input voltage through the first transformer winding.

20. The method as in claim 19, wherein the first transformer winding is disposed in a resonant circuit, the first current being resonant current flowing through the first transformer winding.
